(19) United States
(12) Patent Application Publication
(10) Pub. No.: US 2015/0358217 A1
(43) Pub. Date: Dec. 10, 2015

(54) Web Polling Method, Device and System

(71) Applicants: BEIJING QIHOO TECHNOLOGY COMPANY LIMITED, Beijing (CN); QIZHI SOFTWARE (BEIJING) COMPANY LIMITED, Beijing (CN)

(72) Inventors: Bo Wang, BEIJING (CN); Jianfeng Ye, Beijing (CN)

(21) Appl. No.: 14/759,873

(22) PCT Filed: Dec. 26, 2013
(86) PCT No.: PCT/CN2013/090600

§ 371 Date: Jul. 8, 2015

(30) Foreign Application Priority Data
Jan. 9, 2013 (CN) 201310007881.5

(51) Int. Cl. H04L 12/26; H04L 29/06; G06F 17/30; H04L 29/08

(52) U.S. Cl. CPC H04L 43/04; H04L 67/02; H04L 67/42; G06F 17/30864

(57) ABSTRACT

The present invention discloses a web polling system, comprising at least one client, a web server, and a database server, wherein the client is configured to transmit a web polling request; the database server is configured to push data added locally to the web server in real time; and the web server is configured to store the data pushed by the database server, to query in the data stored by the web server itself upon receiving the Web polling request sent by the client, and to return the found data to the client. The present invention can reduce system load and hardware cost. The present invention further discloses a corresponding device and method.

### FIELD OF THE INVENTION

The present invention relates to the field of communication, and in particular, to a web polling method, device and system.

### BACKGROUND OF THE INVENTION

Web polling means that in the Internet, a client periodically accesses a service terminal through an HTTP (Hypertext Transfer Protocol) way to obtain new data.

Since HTTP is stateless in essence, interaction between the client and the service terminal must be performed in a request/response mode. The commonest architecture of current websites is that a front end uses a web server such as Nginx and a rear end uses a DB (DataBase) server such as MySQL. When the user initiates a user file request, the Nginx server accesses the MySQL server, obtains corresponding data and presents them to the user.

FIG. 1 shows a flow chart of conventional web polling according to the existing art. Referring to FIG. 1, to obtain the newest data, the client constantly queries (requests) to the server at a certain time interval. At the service terminal, the Nginx server transfers the request to the MySQL server, the MySQL server returns a response, and then the Nginx server returns the response to the client.

In the web polling, the client usually intends to quicken the polling frequency to obtain the newest data as quickly as possible, i.e., the time interval between requests will be shortened. However, at the service terminal, the Nginx server and the MySQL server usually belong to different physical servers. When the client quickens the frequency of polling the Nginx server, the Nginx server also quickens the frequency of polling the MySQL server. Since the anti-pressure capability of the MySQL server is usually not as good as the Nginx server, the MySQL server will exhibit high load and thereby causes a shortcoming to the overall performance of the system.

Noticeably, the Nginx server and the MySQL server are only used here for exemplary illustration. The servers used in the implementation procedure are not limited to the Nginx server and the MySQL server.

### SUMMARY OF THE INVENTION

In view of the above problems, the present invention is proposed to provide a web polling method, device and system, which can overcome the above problem or at least partially solve the above problem.

According to an aspect of the present invention, there is provided a web polling system, comprising at least one client, a web server, and a database server, wherein

the client is configured to transmit a Web polling request;

the database server is configured to push data increased locally to the web server in real time; and

the web server is configured to store the data pushed by the database server, to query in the data stored by the web server itself upon receiving the Web polling request sent by the client, and to return the found data to the client.

Optionally, the database server is further configured to:

add an identification ID field for data stored locally as a primary key;

when the ID fields stored locally increase, push the increased ID fields and corresponding data to the web server.

Optionally, the web server is further configured to store the data pushed by the database server in a local shared memory.

Optionally, the web server is further configured to:

compare ID fields received by the client with ID fields stored locally, and judge whether the ID fields stored locally increase;

if a judgment result is yes, return data corresponding to the increased ID fields to the client;

if the judgment result is no, return to the comparison operation.

Optionally, the web server is further configured to:

keep time for connection of the client with the web server itself;

if the kept time period exceeds a preset time period, disconnect the connection with the client.

According to another aspect of the present invention, there is provided a database server, comprising:

an obtaining module configured to obtain data increased locally in real time;

a pushing module configured to push the data obtained in real time to a web server.

Optionally, the pushing module is further configured to:

add an identification ID field for data stored locally as a primary key;

when the ID fields stored locally increase, push the increased ID fields and corresponding data to the web server.

According to a further aspect of the present invention, there is provided a web server, comprising:

a storage module configured to store data pushed by the database server;

a receiving module configured to receive a web polling request sent by the client;

a query module configured to query in the data stored by the storage module and return the found data to the client.

Optionally, the storage module is further configured to store the data pushed by the database server in a local shared memory.

Optionally, the query module is further configured to:

compare ID fields received by the client with ID fields locally stored by the web server, and judge whether the locally-stored ID fields increase;

if a judgment result is yes, return data corresponding to the increased ID fields to the client;

if the judgment result is no, return to the comparison operation.

According to a further aspect of the present invention, there is provided a web polling method, comprising:

receiving a web polling request sent by the client;

querying in the data stored by the web server according to the web polling request and returning the found data to the client;

wherein the database server pushes data increased in itself to the web server in real time, and stores the increased data in the web server.

Optionally, the step of the database server pushing the data increased in itself to the web server in real time comprises:

the database server adds an identification ID field for data stored by itself as a primary key;

when the ID fields stored by the database server increase, the database server pushes the increased ID fields and corresponding data to the web server.

Optionally, the method further comprises the web server storing the data pushed by the database server in a local shared memory.

Optionally, the querying in the data stored by the web server and returning the found data to the client, comprising:

comparing ID fields received by the client with ID fields stored by the web server, and judging whether the ID fields stored by the web server increase;

if a judgment result is yes, return data corresponding to the increased ID fields to the client;

if the judgment result is no, return to the comparison operation.

Optionally, the method further comprises:

keeping time for connection of the web server with the client;

if the kept time period exceeds a preset time period, disconnecting the connection of the web server with the client.

In the embodiment of the present invention, the current Web polling manner is changed, a foreground server no longer turns to the background server for polling to obtain data, and instead, the database server as the background server pushes data to the web server as the foreground server in real time. When the client needs to query for data, the web server only needs to poll in the data stored by itself and does not need to turn to the background server for polling, which substantially reduces the cost. Even if the polling frequency is quickened, overload will not be caused to the background server, thus the hardware shortcoming is solved, requirements for the background server are lowered, and hardware cost is saved. In addition, with the polling cost being lowered, the polling frequency can be quickened, so the client can obtain relevant data by quicker polling so as to achieve a quasi-real-time effect, thus improving the client's experience.

The above description only generalizes technical solutions of the present invention. The present invention may be implemented according to the content of the description in order to make technical means of the present invention more apparent. Specific embodiments of the present invention are exemplified to make the above and other objects, features and advantages of the present invention more apparent.

### BRIEF DESCRIPTION OF THE DRAWINGS

Various other advantages and merits will become apparent to those having ordinary skill in the art by reading through the following detailed description of preferred embodiments. Figures are only intended to illustrate preferred embodiments and not construed as limiting the present invention. In all figures, the same reference numbers denote the same part. In the figures:

FIG. 1 illustrates a flow chart of conventional web polling according to the existing art;

FIG. 2 illustrates a schematic structural diagram of a web polling system according to an embodiment of the present invention;

FIG. 3 illustrates a schematic structural diagram of a database server according to an embodiment of the present invention;

FIG. 4 illustrates a schematic structural diagram of a web server according to an embodiment of the present invention;

FIG. 5 illustrates a flow chart of a web polling method according to an embodiment of the present invention; and

FIG. 6 illustrates an exemplary diagram of a web polling method according to an embodiment of the present invention;

FIG. 7 illustrates a block diagram of a server for implementing the method of the present invention according to an embodiment of the present invention; and

FIG. 8 illustrates a storage unit for maintaining or carrying a program code for implementing the method of the present invention according to an embodiment of the present invention.

### DETAILED DESCRIPTION OF THE INVENTION

The algorithm and display provided herein are not intrinsically related to any specific computer, virtual system or other devices. Various general systems may also be used together with a teaching based on this. According to the above depictions, structures required for constructing such type of systems are obvious. Besides, the present application is not with respect to any specific programming language. It shall be understood that various programming languages may be used to implement the content of the present invention described here, and the above depictions for specific language are intended to reveal preferred embodiments of the present invention.

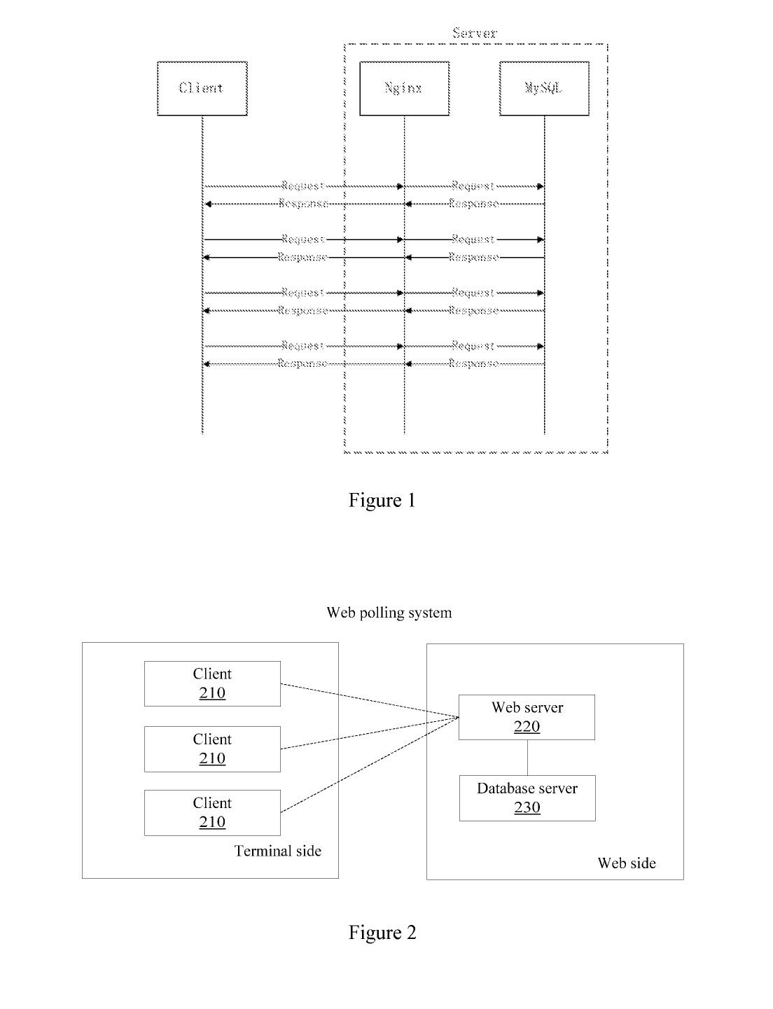

As known from the depictions in the existing art, the biggest drawback of the conventional web polling lies in that it will cause abrupt increase of the load of the rear-end database server. To solve this technical problem, an embodiment of the present invention provides a new web polling system. FIG. 2 illustrates a schematic structural diagram of a web polling system according to an embodiment of the present invention. Referring to FIG. 2, the web polling system at least comprises a client 210, a web server 220 (as a front-end server of a service terminal) and a database server 230 (as a rear-end server of the service terminal). Now specific depictions will be presented with respect to components of the Web polling system and the function of each component.

First, the client 210 is introduced. In the system, the client 210 is configured to send a Web polling request. The number of the clients 210 can be determined according actual situations. In the polling state, usually, there is at least one client 210, or for example, there can be two, three, four or more. In FIG. 2, the number of clients 210 is three, which is only used to illustrate that the number of clients is at least one and not to limit the actual number of the clients.

Secondly, the database server 220 is introduced. Referring to FIG. 2, the database server 220 is coupled to the web server 230. The database server 220 serves as a background server and is configured to push data added locally to the web server 230 in real time to ensure that the data in the web server 230 is the newest, thus achieving real-time updating of the data to provide the newest data to the user, and improving the user's feeding and experience.

Then, the web server 230 is introduced. Referring to FIG. 2, one end of the web server is coupled to the client 210, and the other end of the web server is coupled to the database server 220. As a foreground server of the service terminal, the web server 230 stores the data pushed by the database server 220. Furthermore, upon receiving the Web polling request sent by the client 210, the web server 230 queries in the data stored by the web server 230 itself, and returns the found data to the client 210.

In an embodiment of the present invention, the current Web polling manner is changed, the foreground server no longer turns to the background server for polling to obtain data, and instead, the database server as the background server pushes data to the web server as the foreground server in real time. When the client needs to query for data, the web server only needs to poll in the data stored by itself and does not need to turn to the background server for polling, which substantially reduces the cost. Even if the polling frequency is quickened, overload will not be caused to the background server, thus the hardware shortcoming is solved, requirements for the background server are lowered, and hardware cost is saved. In addition, with the polling cost being lowered, the polling frequency can be quickened, so the client can obtain relevant data by quicker polling so as to achieve a quasi-real-time effect, thus improving the client's experience.

To ensure real-time performance of data pushing, the database server 220, during the pushing, adds an identification ID field for data stored locally as a primary key. Each data has a corresponding ID field. When the ID fields stored locally increase, the increase of the data stored locally is noticed. At this time, the increased ID fields and corresponding data are pushed to the web server 230. Here, many kinds of ID fields can be employed, for example, set a key for each data and use the key as the ID field. Again for example, ID fields are set for local data in turn in order of natural numbers; if four data are original stored, their ID fields are 0-3 respectively; if the ID field 4 occurs, the data must be a newly-added data. Again for example, ID fields can be set for local data with English letters A-Z, as long as information serving as the ID field can play an identifying role.

Furthermore, noticeably, when the database server 220 finds that new data are stored by itself, a trigger in the database server 220 itself or an observer mode in a logical layer code can be used to initiatively notify the web server 230 to facilitate the web server 230 to get prepared for data reception.

During storage of data, the web server 230 preferably stores the data pushed by the database server in a local shared memory. Since the shared memory has a character of sharing by a plurality of processes, all processes in the web server 230 can query for or invoke the data stored in the shared content, which improves the data polling efficiency.

In an embodiment of the present invention, after the web server 230 receives the Web polling request sent from the client 210, it compares ID fields previously received by the client 210 with ID fields locally stored by the web server 230 currently, and judges whether the ID fields locally stored by the web server 230 increase. If a judgment result is yes, data corresponding to the increased ID fields are returned to the client 210, and if the judgment result is no, return to the comparison operation.

During implementation, it is noticeable that after the service terminal sends the increased data to the client 210, the service terminal will disconnect with the client 210 to improve system security. In this example, the web server 230 is connected with the client 210 on behalf of the service terminal, so after the web server 230 sends data to the client 210, the web server 230 disconnects with the client 210.

If the web server 230 does not send new data to the client 210, it remains connected with the client 210. However, considering service stability, if long-term connection is always executed, the stability is easily affected. Hence, the web server 230 can keep time for connection of the client 210 with the web server 230 itself, if the kept time period exceeds a predetermined time period, disconnects the connection with the client 210.

After the disconnection, the client 210 may initiate a Web polling request again, and the flow goes round and round to ensure real-time obtainment of data.

The preceding text introduces the whole Web polling system. Now specific depictions will be presented for the architecture of the database server and the web server therein.

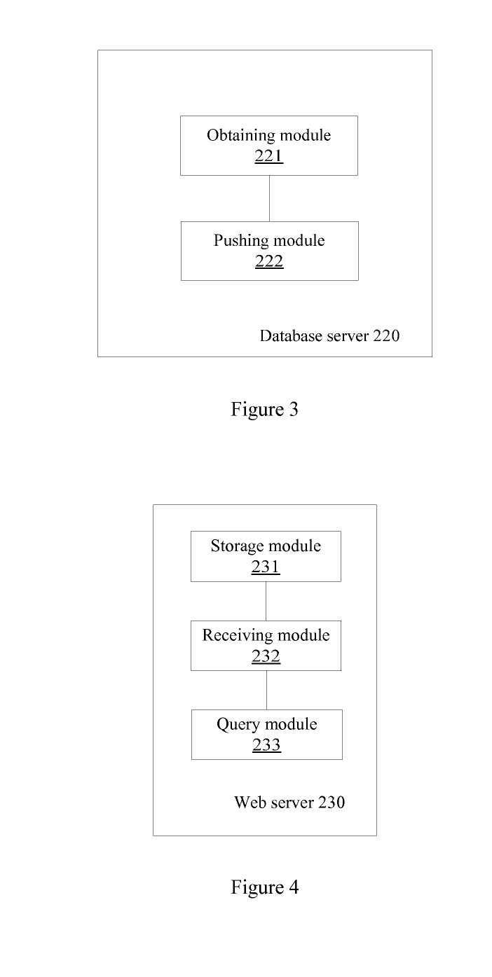

Based on the same inventive idea, an embodiment of the present invention further provides a database server 220. The database server 220 can initiatively push the increased data to the web server 230. FIG. 3 illustrates a schematic structural diagram of a database server according to an embodiment of the present invention. Referring to FIG. 3, the database server 220 at least comprises an obtaining module 221 and a pushing module 222, wherein structures and functions of the modules are presented as follows:

An obtaining module 221 configured to obtain data increased locally in real time;

A pushing module 222 coupled to the obtaining module 221 and configured to push the data obtained in real time to the web server.

Wherein the pushing module 222 can select the following preferred pushing manner: adding an ID field for the data stored locally as a primary key. Subsequently, since the ID fields have a self-increased capability, only the ID fields need to be monitored. When the ID fields stored locally increase, the increased ID fields and corresponding data are pushed to the web server 230.

Based on the same inventive idea, an embodiment of the present invention further provides a web server 230. FIG. 4 illustrates a schematic structural diagram of a web server according to an embodiment of the present invention. Referring to FIG. 4, the web server 230 at least comprises a storage module 231, a receiving module 232 and a query module 233. Specific analysis is hereby performed for functions, structures and connectional relationship of each module.

A storage module 231 configured to store data pushed by the database server 220;

A receiving module 232 configured to receive a Web polling request sent by the client 210;

A query module 233 configured to query in the data stored by the storage module 231 and return the found data to the client 210.

To facilitate all processes to invoke the newly increased data, preferably, the storage module 231 chooses to store the data pushed by the database server 220 in a local shared memory.

In a preferred embodiment, the query module 233 can judge whether the ID fields stored locally increase, by comparing ID fields received by the client 210 with ID fields locally stored by the web server. If the judgment result is yes, the query module 233 return data corresponding to the increased ID fields to the client 210. If the judgment result is no, the query module 233 returns to the comparison operation to continue to compare ID fields received by the client 210 with ID fields locally stored by the web server.

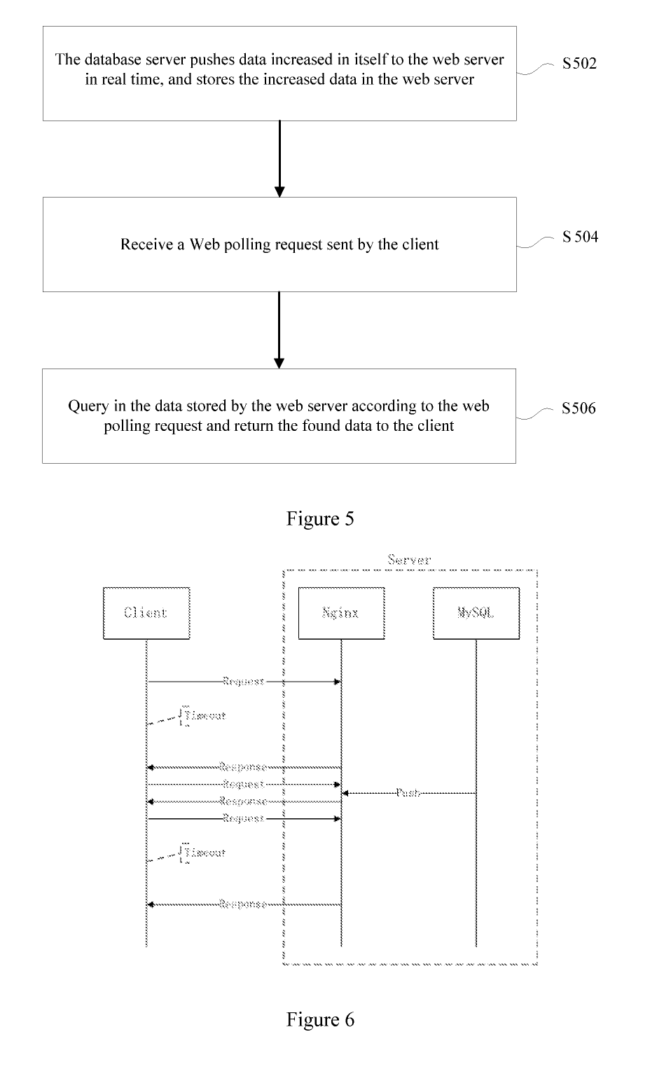

Based on the same inventive idea, an embodiment of the present invention further provides a Web polling method. FIG. 5 illustrates a flow chart of a web polling method according to an embodiment of the present invention. Referring to FIG. 5, the Web polling method comprises step S502 to step S506.

Step S502: the database server pushing data increased in itself to the web server in real time, and storing the increased data in the web server.

Step S504: receiving a Web polling request sent by the client.

Step S506: querying in the data stored by the web server according to the Web polling request and returning the found data to the client.

In the embodiment of the present invention, the current Web polling manner is changed, a foreground server no longer turns to the background server for polling to obtain data, and instead, the database server as the background server pushes data to the web server as the foreground server in real time. When the client needs to query for data, polling only needs to be done in the data stored by the web server itself, and the web server does not need to turn to the background server for polling, which substantially reduces the cost. Even if the polling frequency is quickened, overload will not be caused to the background server, thus the hardware shortcoming is solved, requirements for the background server are lowered, and hardware cost is saved. In addition, with the polling cost being lowered, the polling frequency can be quickened, so the client can obtain relevant data by quicker polling so as to achieve a quasi-real-time effect, thus improving the client's experience.

As mentioned in step S502, the database server pushes the data increased in itself to the web server in real time. To ensure real-time performance of data pushing, an identification ID field is added for data stored locally as a primary key. Each data has a corresponding ID field. When the ID fields stored locally increase, the increase of the data stored locally is noticed. At this time, the increased ID fields and corresponding data are pushed to the web server. Here, many kinds of ID fields can be employed, for example, set a key for each data and use the key as the ID field. Again for example, ID fields are set for local data in turn in order of natural numbers; if four data are original stored, their ID fields are 0-3 respectively; if the ID field 4 occurs, the data must be a newly-added data. Again for example, ID fields can be set for local data with English letters A-Z, as long as information serving as the ID field can play an identifying role.

Furthermore, noticeably, when the database server finds that new data are stored by itself, a trigger in the database server itself or an observer mode in a logical layer code can be used to initiatively notify the web server increase of the data stored locally the web server to get prepared for data reception.

When data are stored in the web server, the data pushed by the database server are preferably stored in a shared memory of the web server. Since the shared memory has a character of sharing by a plurality of processes, all processes in the web server can query for or invoke the data stored in the shared content, which improves the data polling efficiency.

After the web server receives the Web polling request sent from the client, it queries in the data stored by the web server, compares ID fields received by the client with ID fields locally stored by the web server, and judges whether the ID fields locally stored by the web server increase. If the judgment result is yes, data corresponding to the increased ID fields are returned to the client, and if the judgment result is no, return to the comparison operation.

During implementation, it is noticeable that after the service terminal sends the increased data to the client, the service terminal will disconnect with the client to improve system security. In this example, the web server is connected with the client on behalf of the service terminal, so after the web server sends data to the client, the web server disconnects with the client.

If the web server does not send new data to the client, it remains connected with the client. However, considering service stability, if long-term connection is always executed, the stability is easily affected. Hence, the web server can keep time for connection of the client with the web server itself, if the kept time period exceeds a predetermined time period, disconnects the connection with the client.

To more clearly describe the effects achieved by the Web polling method employed by the embodiment of the present invention and form a contrast with the existing art, a specific application environment identical with FIG. 1 is hereby provided for illustration purpose.

FIG. 6 illustrates an exemplary diagram of a web polling method according to an embodiment of the present invention. Since the application environment is identical with FIG. 1, it will not be detailed here. Noticeably, the Nginx server and the MySQL server are only used here for exemplary illustration. The servers used in the implementation procedure of the embodiments of the present invention are not limited to the Nginx server and the MySQL server, i.e., not limited to specific types of database servers and web servers.

Specifically, in this example, assume that data are stored in the MySQL server, one self-increased ID field is used as a primary key.

After the client sends a request, a long-term connection is kept with the service terminal by using a KeepAlive form provided in the HTTP1.1, and meanwhile the newest ID field received by the current user is queried for subsequent use.

In the example, the Nginx server does not initiatively query the MySQL server any longer, and instead the MySQL server initiatively pushes the ID field of the new data to the Nginx server. A specific practice is as follows: when new data is stored on the MySQL server, a trigger of the MySQL server itself or an observer mode in a logical layer code can be used to initiatively notify the front-end Nginx server.

The front-end Nginx server stores the corresponding new data ID field in the Nginx shared memory so that all Nginx processes can used it. Furthermore, Nginx server polling does not need to poll the remote MySQL server any more, and only needs to poll the local shared memory. Since the overhead for polling the local shared memory is lower, the polling frequency can be quickened so as to achieve a quasi-real-time effect, thus improving the client's experience. Meanwhile, since the requests to the rear-end MySQL server are reduced, hardware cost can be saved.

When the client polls the Nginx server, the Nginx server can compare the newest ID received by the user with the newest ID of the system stored in the shared memory. As the ID is self-increased, it is very easy to judge whether the client has a new message (namely, whether there is new data to be sent to the client to update the client's data). Once it is determined that there is a new message, the new message is fed back to the client and the connection is terminated immediately. Subsequently, the client will re-send a Web polling request.

On the contrary, if there is not a new message, the service terminal will keep the connection. However, for the sake of service stability, the long-term connection will not last permanently. A length of time is usually set, once the connection time period reaches the preset length of time, the server terminal will initiatively disconnect. Then, the client will re-initiate a Web polling request, and establish a connection, and the flow goes round and round.

A crucial technical point lies in that local polling is achieved on the basis of the Nginx shared memory to replace traditional remote polling, thereby substantively improving the client's experience and reducing hardware cost.

As can be seen from the above, on the basis of ensuring the method used by the client being compatible with the conventional Web polling solution, embodiments of the present invention effectively lower the load of the rear-end database server, thus making it not be a shortcoming of the overall performance of the system any longer.

The following advantageous effects can be achieved by employing the web polling method, device and system provided by the embodiments of the present invention:

In the embodiments of the present invention, the current Web polling manner is changed, a foreground server no longer turns to the background server for polling to obtain data, and instead, the database server as the background server pushes data to the web server as the foreground server in real time. When the client needs to query for data, the web server only needs to poll in the data stored by itself and does not need to turn to the background server for polling, which substantially reduces the cost. Even if the polling frequency is quickened, overload will not be caused to the background server, thus the hardware shortcoming is solved, requirements for the background server are lowered, and hardware cost is saved. In addition, with the polling cost being lowered, the polling frequency can be quickened, so the client can obtain relevant data by quicker polling so as to achieve a quasi-real-time effect. thus improving the client's experience.

The description as provided here describes a lot of specific details. However, it is appreciated that embodiments of the present invention may be implemented in the absence of these specific details. Some embodiments do not specify detail known methods, structures and technologies to make the description apparent.

Similarly, it should be appreciated that in order to simplify the present disclosure and help understand one or more aspects of the present invention, in the above depictions of exemplary embodiments of the present application, features of the present application are sometimes grouped together to an individual embodiment, figure or depiction thereof. However, the disclosed method should not be interpreted as the following intention: the present application claims more features than the features explicitly recited in each claim. More exactly, as reflected by the following claim set, aspects of the invention are less than all features of an individual embodiment disclosed previously. Therefore, the claim set conforming to a specific implementation mode is thereby explicitly incorporated into this specific implementation mode, wherein each claim itself serves as an individual embodiment of the present application.

Those skilled in the art may appreciate that modules in the apparatus in the embodiment may be changed adaptively and they are set in one or more apparatuses different from the present embodiment. Modules or units or assemblies in the embodiment may be combined into one module or unit or assembly, and besides, they may be divided into a plurality of submodules, subunits or subassemblies. Except that at least some of such features and/or processes or units are mutually repellent, all features disclosed in the specification (including the accompanying claims, abstract and figures) and all processes or units of any method or apparatus disclosed in this way may be combined by employing any combination. Unless otherwise stated expressly, each feature disclosed in the specification (including the accompanying claims, abstract and figures) may be replaced with an alternative feature providing identical, equivalent or similar objective.

In addition, those skilled in the art can understand that even though some embodiments described here include some features other than other features included in other embodiments, combination of features of different embodiments means being within the scope of the present application and forming different embodiments. For example, in the appended claim set, any one of the claimed embodiments may be used in an arbitrary combination manner.

Embodiments regarding parts in the present invention may be implemented in hardware, or implemented by software modules running on one or more processors, or implemented in their combinations. Those skilled in the art should understand that a microprocessor or digital signal processor (DSP) may be used in practice to implement some or all functions of some or all parts of the apparatus according to embodiments of the present invention. The present invention may also be implemented as an apparatus or device program (e.g., computer program and computer program product) for executing part or all of the method described here. Such programs implementing the present invention may be stored in a computer-readable medium, or may be in a form having one or more signals. Such signals can be obtained by downloading from the Internet, or provided on a carrier signal or provided in any other forms.

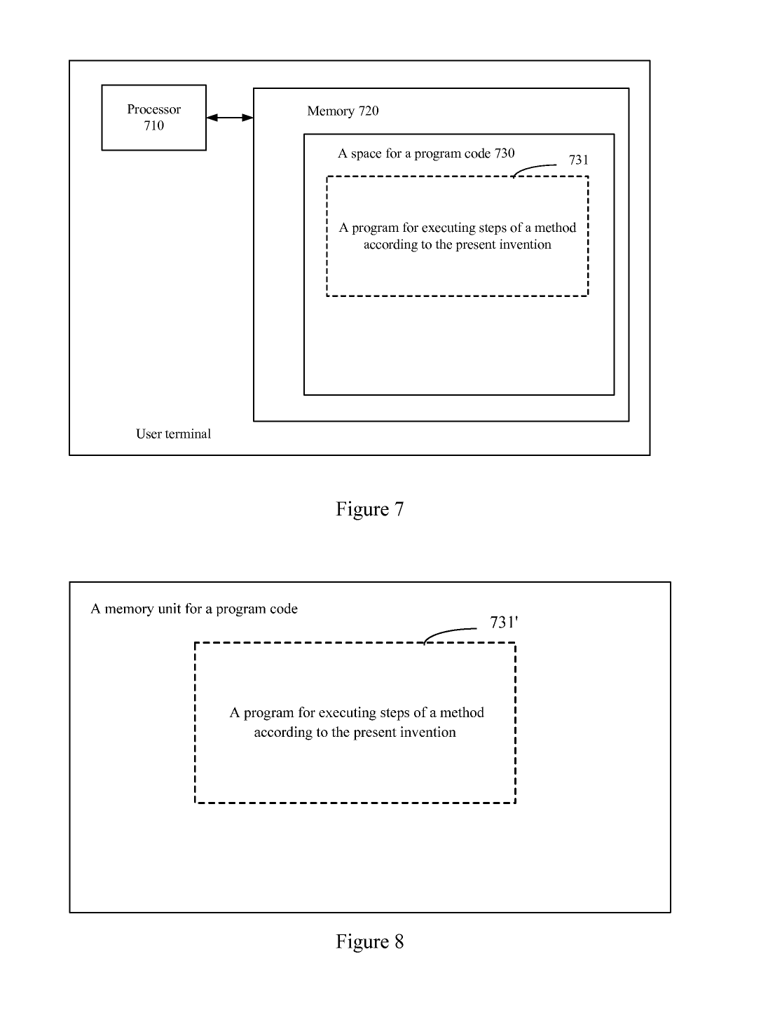

For example, FIG. 7 illustrates a server for implementing the Web polling method of the present invention according to an embodiment of the present invention. The user terminal conventionally comprises a processor 710 and a computer program product or computer-readable medium in the form of a memory 720. The memory 720 may be a flash memory, EEPROM (Electrically Erasable Programmable Read-Only Memory), EPROM, hard disk or ROM-like electronic memory. The memory 720 has a storage space 730 for a program code 731 for executing any step of the above method. For example, the storage space 730 for the program code may comprise program codes 731 respectively for implementing steps of the above method. These program codes may be read from one or more computer program products or written into the one or more computer program products. These computer program products comprise program code carriers such as hard disk, compact disk (CD), memory card or floppy disk. Such computer program products are usually portable or fixed memory units as shown in FIG. 8. The memory unit may have a storage section, a storage space or the like arranged in a similar way to the memory 720 in the user terminal of FIG. 7. The program code may for example be compressed in a suitable form. Usually, the memory unit includes a computer-readable code 731′, namely, a code readable by a processor for example similar to 710. When these codes are run by the server, the server is caused to execute steps of the method described above.

Reference herein to “one embodiment”, “an embodiment”, or to “one or more embodiments” means that a particular feature, structure, or characteristic described in connection with the embodiments is included in at least one embodiment of the invention. Further, it is noted that instances of the phrase “in one embodiment” herein are not necessarily all referring to the same embodiment.

The description as provided here describes a lot of specific details. However, it is appreciated that embodiments of the present invention may be implemented in the absence of these specific details. Some embodiments do not specify detail known methods, structures and technologies to make the description apparent.

It should be noted that the above embodiment illustrate the present invention but are not intended to limit the present invention, and those skilled in the art may design alternative embodiments without departing from the scope of the appended claims. In claims, any reference signs placed in parentheses should not be construed as limiting the claims. The word “comprising” does not exclude the presence of elements or steps not listed in a claim. The word “a” or “an” preceding an element does not exclude the presence of a plurality of such elements. The present invention may be implemented by virtue of hardware including several different elements and by virtue of a properly-programmed computer. In the apparatus claims enumerating several units, several of these units can be embodied by one and the same item of hardware. The usage of the words first, second and third, et cetera, does not indicate any ordering. These words are to be interpreted as names.

In addition, it should be noted that the language used in the specification has been principally selected for readability and instructional purposes, and may not have been selected to delineate or circumscribe the inventive subject matter. Therefore, those having ordinary skill in the art appreciate that many modifications and variations without departing from the scope and spirit of the appended claims are obvious. The disclosure of the present invention is intended to be illustrative, but not limiting, of the scope of the invention, which is set forth in the claims.

1. A web polling system, comprising at least one client, a web server, and a database server, wherein
the client is configured to transmit a Web polling request;
the database server is configured to push data increased locally to the web server in real time; and
the web server is configured to store the data pushed by the database server, to query in the data stored by the web server itself upon receiving the Web polling request sent by the client, and to return the found data to the client.

2. The system according to claim 1, characterized in that the database server is further configured to:
add an identification ID field for data stored locally as a primary key;
when the ID fields stored locally increase, push the increased ID fields and corresponding data to the web server.

3. The system according to claim 1, characterized in that the web server is further configured to store the data pushed by the database server in a local shared memory.

4. The system according to claim 1, characterized in that the web server is further configured to:
compare ID fields received by the client with ID fields stored locally, and judge whether the ID fields stored locally increase;
if a judgment result is yes, return data corresponding to the increased ID fields to the client;
if the judgment result is no, return to the comparison operation.

5. The system according to claim 1 characterized in that the web server is further configured to:
keep time for connection of the client with the web server itself;
if the kept time period exceeds a preset time period, disconnect the connection with the client.

6. (canceled)

7. (canceled)

8. (canceled)

9. (canceled)

10. (canceled)

11. A web polling method, comprising:
receiving a web polling request sent by a client;
querying in data stored by a web server according to the web polling request and returning the found data to the client;
wherein a database server pushes data increased in itself to the web server in real time, and stores the increased data in the web server.

12. The web polling method according to claim 11, characterized in that the step of the database server pushing data increased to itself to the web server in real time comprises:
the database server adds an identification ID field for data stored by itself as a primary key;
when the ID fields stored by the database server increase, the database server pushes the increased ID fields and corresponding data to the web server.

13. The web polling method according to claim 11, characterized in that the method further comprises the web server storing the data pushed by the database server in a local shared memory.

14. The web polling method according to claim 11, characterized in that the querying in data stored by the web server and returning the found data to the client, comprising:
comparing ID fields received by the client with ID fields stored by the web server, and judging whether the ID fields stored by the web server increase;
if a judgment result is yes, return data corresponding to the increased ID fields to the client;
if the judgment result is no, return to the comparison operation.

15. The web polling method according to claim 11, characterized in that the method further comprises:
keeping time for connection of the web server with the client;
if the kept time period exceeds a preset time period, disconnecting the connection of the web server with the client.

16. (canceled)

17. A non-transitory computer readable medium having instructions stored thereon that, when executed by at least one processor, cause the at least one processor to perform operations for web polling, which comprises the steps of
receiving a web polling request sent by a client;
querying in data stored by a web server according to the web polling request and returning the found data to the client;
wherein a database server pushes data increased in itself to the web server in real time, and stores the increased data in the web server.
